(19) United States
(12) Patent Application Publication
(10) Pub. No.: US 2008/0089200 A1
(43) Pub. Date: Apr. 17, 2008

(54) Quality Testing Method for Optical Data Carriers

(75) Inventor: Martin Neckmar, Bara (SE)

Correspondence Address: MERCHANT & GOULD PC, P.O. BOX 2903, MINNEAPOLIS, MN, 55402-0903, US

(73) Assignee: Audiodev Aktiebolag, Malmo (SE)

(21) Appl. No.: 11/596,716

(22) PCT Filed: May 20, 2005
(86) PCT No.: PCT/SE05/00746

§ 371 Date: Jan. 7, 2008

(30) Foreign Application Priority Data
May 24, 2004 (SE) 0401318-1
May 25, 2004 (US) 60/573,848

(51) Int. Cl. G11B 20/18; G11B 5/58; G11B 27/36; G11B 7/00

(52) U.S. Cl. 369/53.2

(57) ABSTRACT

A method is disclosed for testing the overall quality of an optical disc of the type that stores optically readable information in the form of a spiral or annular pattern defining a plurality of concentric tracks. When a signal from a disc player's laser pickup is below a certain threshold, indicating that the pickup is locked to a track, measurements are performed in the Tracked operation mode. Leaps are performed in radial direction of the disc when statistically sufficient data is received in the Tracked mode. During the leaps, the quality of the disc is evaluated in an Off-Track mode. By repeating these steps, the quality of an entire disc is thus evaluated much faster than with traditional methods or equipment and independent of the disc's eccentricity.

### FIELD OF THE INVENTION

This invention pertains in general to the field of quality testing equipment and quality testing methods for optical data carriers, and more specifically to a method for quality testing of disc shaped optical data carriers, and even more particularly to a method for controlling the overall quality of an optical disc of the type that stores optically readable information in the form of a spiral or annular pattern defining a plurality of concentric tracks.

### BACKGROUND OF THE INVENTION

Optical data carriers are used for storing very large amounts of digital information, which represent for instance music, video, images or digital data for computers, such as program files and data files. The most common type of optical data carriers are the compact disc (CD) and the Digital Versatile Disc (DVD), which are available in several different data formats, among which CD-Audio, CD-ROM, CD-ROM XA, CD-I, CD-R, CD-RW, DVD Video, DVD-R/+R/-RW/+RW, and DVD-Audio are the most common. The standard for compact discs was established some decades ago and has been in use ever since. The DVD was introduced in recent years and is a more sophisticated type of optical data carrier. Further more recent formats are the Super Audio CD (SACD), and the latest formats emerging on the market are the Blu-Ray Disc (BD), the Small Form Factor Optical Storage Disc (SFFO), and the High Definition DVD (HD-DVD formerly called AOD).

A common feature of the optical storage discs above is that they store very large amounts of information in a small area. The digital information is read at high precision by means of a laser beam, and even if the information is stored on the optical discs according to error-correcting encoding methods, there is a large demand among manufacturers and distributors of such optical discs to be able to check the quality of the optical discs. It is an absolute requirement to fulfill the specifications from Philips and Sony for CD, from DVD Forum for DVD and AOD/HD-DVD, and from Sony for BD, so as to ascertain a minimal number of errors and deficiencies among the optical storage discs, mainly in their information-carrying layer.

Therefore, the quality of optical storage discs is evaluated during the manufacturing process of the discs. A variety of parameters are measured and registered, both physical parameters (such as skewness, eccentricity, cross talk, etc.) and logical errors (various rates of bit errors, block errors and burst errors). Other important parameters are the degree of birefringence in the transparent plastic layer of an optical disc and so-called jitter, i.e. statistical time variations in the signal obtained when reading or playing the optical disc. Moreover, a very important parameter related to the quality of the optical disc is the signal amplitudes that are obtained when reading the optical disc with a laser pickup.

As is generally known, a normal optical disc is based on an about 1.2 mm thick plastic disc having a diameter of 8 or 12 mm. The CD format has a substrate thickness for the read out laser of 1.2 mm minus protective lacquer on the label side. The DVD and the HD DVD consist of two 0.6 mm substrates glued together. The BD consists of a 0.1 mm substrate glued or spin coated on to a 1.1 mm disc, where the 0.1 mm side is the read out side. The plastic disc is normally manufactured as an injection-moulded piece of clear polycarbonate plastic, but for Blu-ray Disc spin coating of the 0.1 mm substrate might become a popular manufacturing method. One technique used for applying the thin 0.1 mm substrate is to attach the substrate as a film. During manufacturing, the plastic disc is impressed with microscopic bumps arranged as a single, continuous spiral pattern that represents the information stored on the CD. A stamper is used for impressing this spiral pattern of microscopic bumps. Once the clear piece of polycarbonate disc has been formed, a thin reflective aluminium layer is sputtered onto the disc, thereby covering the spiral pattern of bumps. Then, a thin photopolymer layer is applied to the aluminium to protect it. Finally, a CD label is printed onto the photopolymer layer in case of a CD. If the disc is a DVD or HD-DVD several information layers can be applied by using semi reflective materials such as silicone. The two 0.6 mm discs are then being glued back to back in order to form a 1.2 mm thick disc, containing information on either of the sides or both. For Blu-ray Disc the tentative manufacturing technique is to injection mould the 1.1 mm disc, sputter the reflective layer, then apply the 0.1 mm substrate, either by spin coating or by attaching a 0.1 mm film. The last step is to add a protective coating.

The bumps in the spiral pattern are normally referred to as pits, since this is how they appear when viewed from the aluminium layer. The areas between adjacent pits are normally referred to as lands or plane areas.

Each turn or revolution of the continuous spiral pattern essentially forms a circular track, which is concentric with the following turn or revolution of the spiral pattern. Therefore, a CD is often described as having a plurality of circular tracks, even if they in reality are coupled to each other in a single continuous spiral pattern. A CD has about 22,000 tracks, whereas a DVD has about 47,000 tracks, a HD-DVD about 90,000 tracks and a BD about 110,000 tracks.

FIG. 1 illustrates an optical disc 1, such as a CD, DVD, HD-DVD or Blu-Ray Disc, with its single continuous spiral pattern 2, which in the case of pre-mastered discs comprises pits and plane areas. As described, the spiral pattern 2 forms a plurality of essentially concentric circular tracks 3. The optical disc 1 has a center opening 5 for engagement with a drive spindle to rotate the optical disc 1.

FIG. 2 illustrates a few tracks 3 having information digitally recorded on them in more detail. The information is, as mentioned above, stored in pits (or bumps) that are indicated at 6, and intermediate plane areas (or lands) are indicated at 7.

As already mentioned, a stamper is used when producing optical media, both pre-mastered and recordable. A disc master is the geometrical origin of a stamper and may be produced by applying a thin layer of photoresist or another removable material onto a glass disc. A mastering device is continuously moved radially from the center of the glass disc towards its periphery and exposes the photoresist layer in a pattern which corresponds to the desired spiral pattern of pits and plane areas on the end product, i.e. the optical disc. On recordable discs the mastering device exposes the photo resist layer in a continuous wobbling pattern containing encoded sector information. Obviously, it is very important that the pits are clearly distinguishable from the lands on the optical disc. More specifically, pits of different size need to be properly identified when reading the optical disc. On the recordable disc it is important that the wobble groove is properly defined in order for the recorder to be able to track and record on the discs.

Since the pits or the wobble groove of the stamper are not optimized for reading, the signal produced when reading the stamper is different from the signal from the resulting disc. Furthermore, when manufacturing an optical disc, each production line has its own characteristics regarding how the pit- or groove structure is affected between the stamper and the disc. Hence, the quality control has to be performed on the disc itself. Moreover, it is important to have a fast and reliable quality feedback concerning the manufactured discs in order to be able to quickly adjust the manufacturing process of the discs. For this purpose, the discs are read in a disc player and the quality of the discs is evaluated. Of course, generally the entire disc and its quality need to be evaluated and therefore, up to now, the entire disc is read in order to measure the signals associated with the entire optical disc.

Traditional test equipment for optical media is designed for measuring and analysing the electrical and physical signals of pre-mastered, recordable and rewriteable discs. A complete test in nominal speed (1×) lasts for over one hour, and the fastest test equipment today measures a complete disc in approx. 20 minutes when testing in 4 times of nominal speed (4×). Today, this is the fastest time to have a full evaluation of an optical storage disc performed during manufacturing. During this time a large number (typically around 1000) discs may be produced on the production line that have to be discarded in case quality of the manufactured discs proves to be too poor during a quality control. This is especially annoying when adjusting the manufacturing process at start-up, where many cycles of producing/testing/adjusting are necessary. Therefore, the industry is in great need of cutting down the time needed for quality testing of optical storage discs during manufacturing.

Traditional testing is based on two major methods: Tracked measurements and Non-Tracked measurements (also called Off-Tracked measurements or Open Loop). When measuring in tracked mode, the laser pickup follows the blank, recorded or pre-mastered track and the radial and focus servos are locked to the track.

In Off-Tracked measurements, according to the prior art, the radial servo is disabled and the laser pickup is fixed in one radial position. Because of the eccentricity of the optical disc, several tracks will pass the pickup head and it is possible to measure several combinations of signals from the laser pickup, which today most commonly is a quadrant photo detector. This is though, a time consuming method as many positions are to be measured and each position takes at least five seconds to measure with current technology. Hence, it is up to now practically impossible to completely measure and evaluate an entire disc in Off-tracked mode. For instance ten thousand measurement positions are necessary when the eccentricity generates about five tracks passing the pickup head, wherein each measurement takes about five seconds. Thus it would take about 14 hours for testing a single disc with Off-Tracked measurements. In case eccentricity is even lower, the process would take even longer as all tracks have to be evaluated. In the case of a concentric disc, i.e. the disc has no or very low eccentricity, it is not possible to get any Off-Tracked measurements by means of traditional Off-Tracked measurement systems as no tracks pass the pickup head that is locked to one radial position. Nowadays, in a typical test case 10 to 20 positions for Off-Tracked measurements are performed, taking up to one minute each including positioning. However, in this case only a fraction of the entire disc is tested.

Hence, the quality testing of optical storage discs performed today has several disadvantages. Firstly, the quality evaluation process takes a lot of time when signals are measured continuously on all tracks or across the tracks. Furthermore, if the disc does not have any eccentricity, it is very difficult to measure the signals in Off-Tracked mode (open loop) with high accuracy and repeatability. Thus, there is a need for a new faster way of testing the overall quality of an optical disc of the type that stores optically readable information in the form of a spiral or annular pattern defining a plurality of concentric tracks. There is also a need to be able to perform Open Loop measurements on discs with low eccentricity.

### SUMMARY OF THE INVENTION

The present invention overcomes the above identified deficiencies in the art and solves at least the above identified problems by providing a method and a computer readable medium according to the appended patent claims.

The general solution according to the invention is based on the fact that most defects, such as for instance scratches on the surface of the disc, air bubbles in the clear plastic material of the disc, or irregularities from the stamping process in the characteristic pattern stored on the disc, have an extent exceeding a certain smallest measure, approximately 50-100 μm (about 10-20% of the thickness of a human hair!). With regard to the method of the invention, this means that it is not always necessary to measure all tracks or radii. The defects will be found anyway, as the following example illustrates. If for instance every 100th track is read in Tracked mode, the leap is performed over 100 tracks in Off-Track, approximately 500 times for a DVD. 100 tracks of a DVD are approximately 74 μm apart. Therefore a defect in the above mentioned size of 50-100 μm is either detected during the Tracked mode, during the leap in the Off-Tracked mode or during the next Tracked mode after the leap.

According to aspects of the invention, a method and a computer readable medium for testing the overall quality of an optical disc of the type that stores optically readable information in the form of a spiral or annular pattern defining a plurality of concentric tracks are disclosed.

According to one aspect of the invention, a method is provided, wherein the method comprises the following steps. Firstly, said an optical disc is set in rotation for optically reading out the disc in different operation modes by a disc player that has a read-out device for the disc. Subsequently, the following steps are intermittently alternated for quality testing the disc:

a) at least one first track of said spiral or annular pattern is at least partly read out in a Tracked operation mode of the read-out device for determining Tracked quality parameters, and

b) a leap is carried out in radial direction of the disc and simultaneously the disc is analysed in an Off-track measurement operation mode during the leap for determining Off-Track quality parameters.

According to a further aspect of the invention, a computer readable medium having embodied thereon a computer program for processing by a computer is provided. The computer program comprises code segments for performing the method according to the invention, said code segments namely being a first code segment for setting a disc in rotation for optically reading out the disc in different operation modes by a disc player having a read-out device for the disc. For quality testing of the disc second and third code segments are intermittently alternated. More precisely, the second code segment is at least partly reading out at least one first track of the spiral or annular pattern in a Tracked operation mode of the read-out device for determining Tracked quality parameters, and the third code segment is performing a leap in radial direction of the disc and simultaneously analysing the disc in an Off-track measurement operation mode during the leap for determining Off-Track quality parameters.

The present invention has the advantage over the prior art that it provides timesaving testing and quality control of pre-mastered, recordable and rewriteable optical storage media of the above mentioned types. It allows furthermore testing of replicated optical storage media with single or multiple layer structures, such as for instance DVD-5, DVD-9, DVD-10, DVD-14, DVD-18. The method according of the invention is substantially independent of the read-out speed and reduces the test time by at least 85% compared to known methods, thanks to the “high-speed scanning” of the optical disc. Still, the present method is in accordance with existing and future standards, e.g. of the DVD Forum. By means of the method according to the invention, a quick overview is given over the quality of a disc. Areas having defects are identified quickly and may be further analysed by other quality testing systems. Thus, manufacturers of such optical storage media may improve their feedback times and are during manufacturing able to more quickly optimise the manufacturing process, which leads to increased yields and better use of the production line.

Furthermore, the method according to the invention is independent of any eccentricity of the disc that is evaluated. As mentioned above, Off-Tracked measurements are usually not possible with perfectly or nearly concentric discs i.e. high-speed discs, as in this case no tracks pass the locked pickup head in radial direction. However, with the present method it is perfectly possible to perform Off-Tracked measurements during the leaps, as it is ensured that tracks pass the read-out device in radial direction during the leaps that are performed.

Moreover, it is yet another advantage that Off-Tracked measurements are derived for a large percentage of a disc, compared with traditionally only a few radial points on an entire optical disc.

### BRIEF DESCRIPTION OF THE DRAWINGS

Further objects, features and advantages of the invention will become apparent from the following description of a preferred embodiment of the present invention; reference being made to the accompanying drawings, in which

FIG. 1 is a schematic illustration of an optical disc and a continuous spiral pattern forming a plurality of concentric tracks;

FIG. 2 is a schematic illustration of a small area of a few of the tracks on the optical disc of FIG. 1 having exemplary information recorded thereon;

FIG. 3 is a schematic illustration of the radial direction in which the embodiment of the invention proceeds during a complete quality test of an optical disc of FIG. 1;

FIG. 4 illustrates the appearance of the measured signal during different instances of the measurement process;

FIG. 5 is a schematic illustration of a Quadrant photo detector with relation to the track direction;

FIG. 6 is a schematic illustration of the measurements performed by means of a quality testing method according to the preferred embodiment of the invention;

FIG. 7 is a schematic block diagram of a quality testing apparatus adapted to perform the quality testing method for an optical disc according to the present invention;

FIG. 8 illustrates an operation mode detection principle, used in conjunction with the preferred embodiment of the invention; and

FIG. 9 is a schematic flowchart diagram of a quality testing method according to the preferred embodiment of the invention.

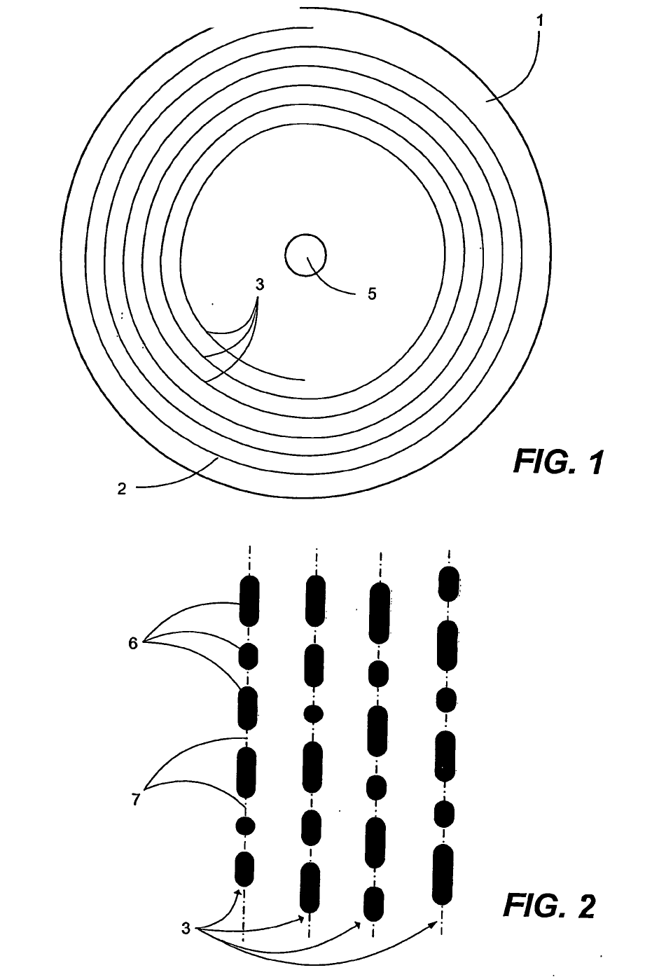

### DESCRIPTION OF EMBODIMENTS

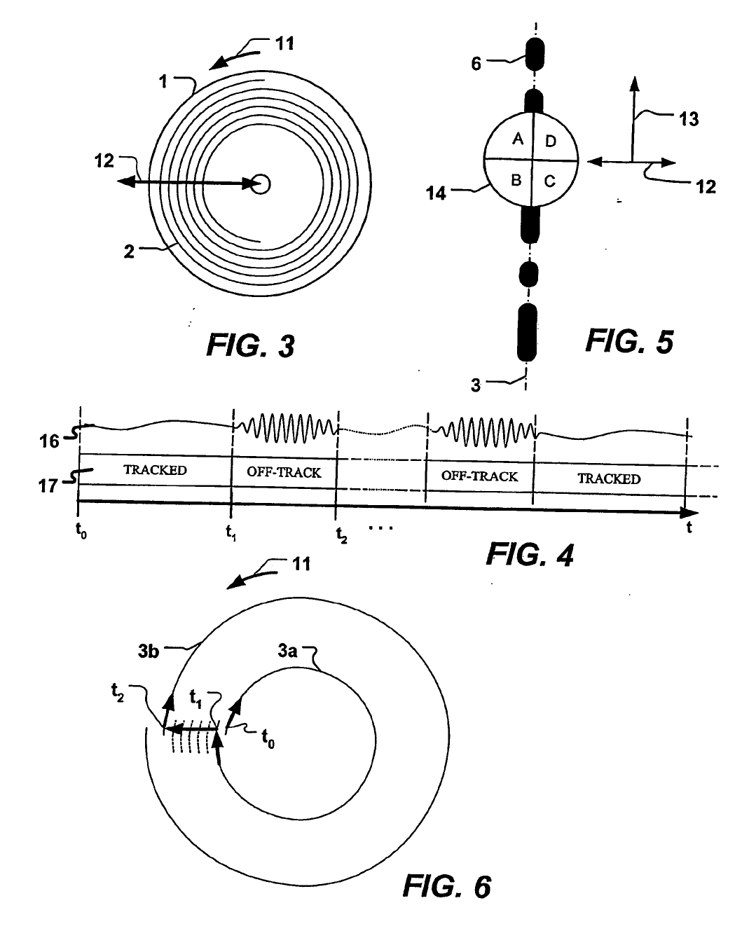

A preferred embodiment of the invention will now be described in detail with reference to FIGS. 3 to 9.

Basically, a disc player is alternatingly changing between a Tracked operation mode and a Non-Tracked operation mode, i.e. the player is intermittently made to perform radial leaps for changing radial positions on the disc. Small samples of data are measured while the player is tracking the disc, i.e. in the Tracked operation mode. Then data is also measured during the changes of the player's radial position, i.e. in the “Off-Track” operation mode. This means, in contrast to traditional Off-Track measurements with a locked radial position of the pickup head, Off-Track measurements with reference to the present invention are performed with a pickup head being “unlocked” in the radial position. Thus, the pickup head will move relative the tracks on the optical disc, even when the disc has very low eccentricity.

By tracking the disc for a limited period of time and by performing many changes of the radial position, the samples taken represent a full measurement of the entire disc but are performed in a significantly shorter time period than traditional measurements. By jumping a short distance between the radial positions, for instance 75 μm, all major defects will be detected on the disc. The result is that it is possible to measure and cover a complete disc in approximately less than 2-3 minutes.

By monitoring the signals derived directly from the disc player's laser pickup, the measurement system has a very quick method of determining whether the current reading operation mode is Tracked or Off-Track. This is done without waiting for that type of information from the disc player, although the disc player may also deliver this information from its radial servo mechanism. However, the radial servo mechanism is rather slow compared to directly analysing the signals from the disc player's laser pickup. The disc player's radial servo mechanism is so slow because it basically waits until several tracks are read, before it confirms that the current mode is Tracked. Hence, waiting for the disc player's hardware to confirm Tracked operation mode after a leap would render the present quality control method unnecessarily slow due to a waste of time when waiting for the disc player to confirm Tracked operation mode.

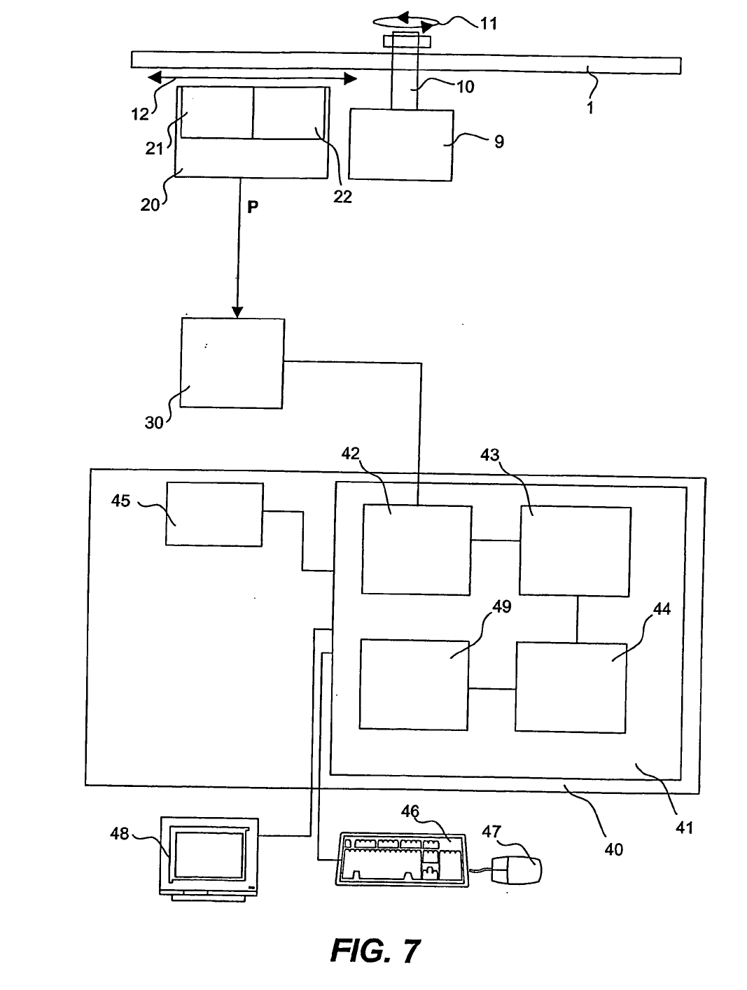

More precisely, according to the present embodiment of the invention the radial error signal of the laser pickup is used to determine the current tracking mode, i.e. the Tracked operation mode or the Off-Track operation mode. However, in other embodiments, other pickup signals suitable for determining the current tracking mode directly, may also be used instead of the radial error signal. In case the radial error signal has an amplitude, i.e. a peak to peak value, or an absolute value over a predetermined threshold value, this indicates that the current operation mode is Off-Track. In the other case, i.e. when the signal amplitude is below the predetermined threshold value, the current operation mode is determined to be the Tracked operation mode. The threshold is chosen appropriately. This is illustrated in more detail with reference to FIG. 7. Due to this immediate feedback of the current operation mode, it is now possible to switch between the two operation modes virtually without any time delay. Thus, the measurement system carrying out the present method has a very quick way of determining Tracked or Off-Track operation mode. Therefore, measurements within those two modes can be performed ‘back to back’, thus reducing the total measurement time even further. It is also pointed out that the time of each leap is known, as the radial speed, acceleration, and deceleration of the current hardware will generally be known. This means that a pulse given to the radial actuator of the disc player has a defined length during which Off-Track measurements are performed. Shortly after the pulse has declined, the Tracked operation mode is expected to start. Hence, the above mentioned amplitude of the signal may also be regarded only in defined time windows to increase reliability of the method.

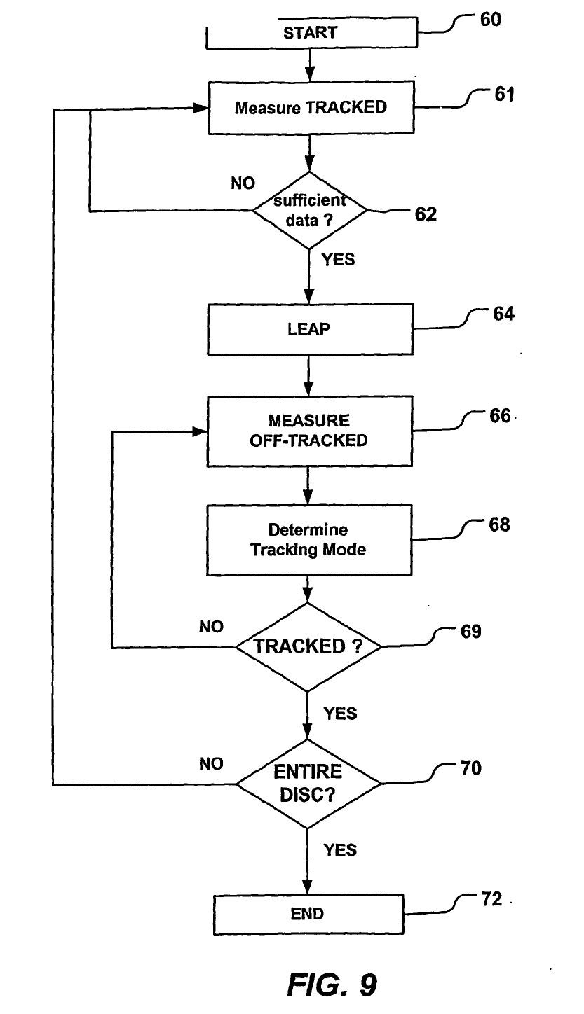

Now turning to the measurement itself, the measurement can be started in either Tracked or Off-Track mode. In the example below, which is illustrated in FIG. 4, FIG. 6 and FIG. 9, the measurement is assumed to be started in the Tracked mode:

1. By monitoring the signal 16 from the disc player's laser pickup, the measurement system's tracking algorithm (not the disc player's radial servo) determines the tracking mode as Tracked, as illustrated at 17 in FIG. 4. As soon as the measurement system detects that the tracking mode is Tracked, measurement of Tracked parameters is begun.

2. Measurement of Tracked parameters of track 3a is performed, starting at t₀.

3. When a statistically sufficient amount of data is measured in the Tracked mode, the measurement system orders the disc player to change radial position at t₁, i.e. to perform a short leap in the radial direction across the disc.

4. By monitoring the signals from the disc player's laser pickup, the measurement system's Tracking-algorithm determines when the disc is in Off-Track mode, i.e. during the short leap.

5. While the disc is in Off-Track mode, measurement of Off-Track parameters is performed until t₂.

6. The above sequence from points 2. to 5. is then repeated throughout a portion of the disc to be evaluated or throughout the entire disc until the quality of that portion or of the entire disc is evaluated.

Examples of parameters to be measured in each of the both operation modes, are given in the attached appendix which is part of this specification. A Quadrant photo detector 14 of a laser pickup is schematically illustrated in FIG. 5. The detector comprises four detecting parts A, B, C, and D, which independently of each other receive laser light reflected from an optical storage disc at read out. The Quadrant photo detector 14 moves in Tracked operation mode relative a track 3, and in Off-Tracked operation mode in a direction perpendicular to the tangential direction of the track, namely in the radial direction 12, as illustrated in FIG. 5. Other photo detectors may be used in different embodiments than the present embodiment.

In a practical non-limiting example of a tested DVD, which is schematically illustrated in FIG. 6, three to four (for illustrative purposes illustrated as one track) tracks 3a are read in Tracked mode starting at t₀ according to step 2 until statistically sufficient data is present at t₁ to proceed with step 3. The player is instructed to leap about 100 tracks (illustrated as dashed lines) in the radial direction, i.e. about 50-70 μm across the disc. Most defects in or on the discs are at least in this order of magnitude, e.g. a grain of dust on or in the disc. During the leap, quality parameters are evaluated in the Off-Track mode (step 5). This takes about 20 milliseconds or 1-2 revolutions of the disc. When the signals from the disc player's laser pickup at t₂ indicate that Tracked mode is once again established, the measurement process is repeated until the end of the disc is reached after about 500 leaps or in less than three minutes. However, this time may be shortened further by e.g. increasing the speed of the player and/or the radial speed of the pickup device. The arrows indicated in bold style in FIG. 6 indicate the “virtual” relative direction in which the pickup head collects measurement signals as it proceeds relative the disc. In reality, the disc is rotating and the pickup head moves only in radial direction 12.

FIG. 7 gives an overview of a quality testing apparatus performing the above described method. A disc drive 9, 10 in the form of a spindle motor 9 and a rotatable spindle 10 is adapted to rotate the optical disc 1 in a direction indicated by 11 in FIGS. 3, 6 and 7, in a manner which is well known in the art. A laser pickup unit 20 is positioned close to one surface of the optical-disc 1 and is movable in a radial direction of the optical disc 1, as is indicated by the arrow 12 in FIG. 3. The laser pickup unit 20 operates to irradiate the optical disc 1 with a beam of laser light, detect reflections from the optical disc, produce a measurement signal in response thereof and provide this signal, labelled P—Pickup—in the drawings. During the proceeding of the above described quality testing method, the optical disc 1 will be kept in rotation by the disc drive, i.e. the spindle motor 9 and the spindle 10.

As mentioned above, the laser pickup unit 20 comprises mechanical drive means 22 for causing the optical assembly or optical read device 21 of the laser pickup unit 20 to move radially along the surface of the optical disc 1 in the direction of arrow 12 indicated in FIG. 3, intermittently between different radial positions. However, such mechanical drive means 22 are well known per se in the technical field, and it is left to the skilled person to choose the suitable mechanical and electrical components, such as an electric motor and a mechanical carriage arrangement, depending on an actual application. In essence, any equipment will do, which is capable of making the optical components 21 of the laser pickup unit 20 move with high precision in the desired radial direction. Furthermore, the laser source may be chosen among a variety of commercially available components and may operate in a desired wavelength range, for instance at about 800 nm for a CD, 650 nm for a DVD or 405 nm for a BD.

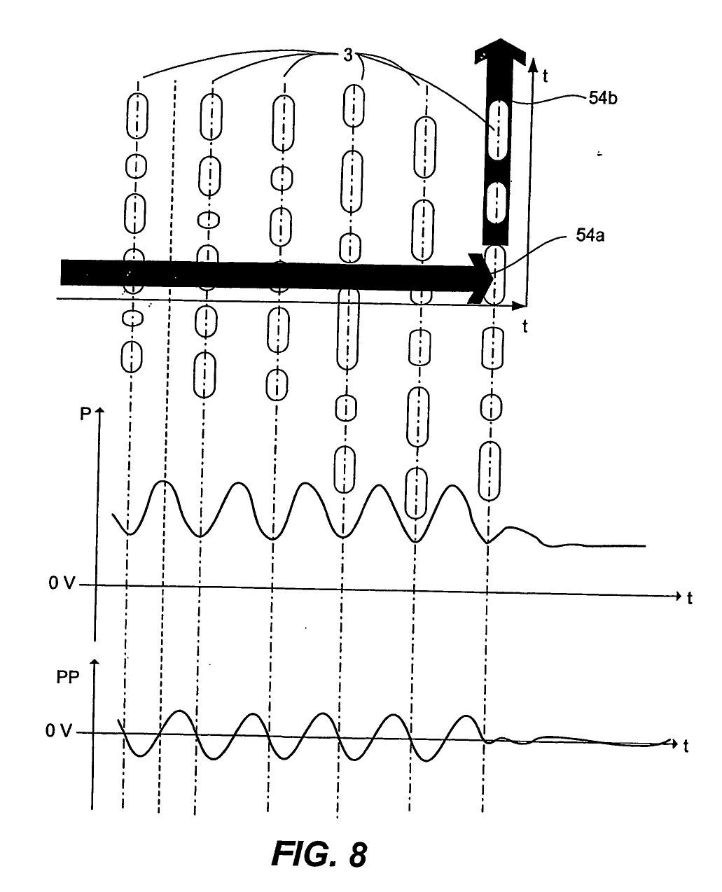

The output signal P from the laser pickup unit 20 comprises a low frequency filtered signal that arises from the intensity variations of the reflected beam from a spot cast by the laser pickup unit 20 when it moves in a radial direction over the surface crossing the tracks of the optical disc 1. This signal is illustrated in FIG. 8. When the spot is at the center of a pit 6 or a weak wobble track on an unrecorded recordable disc, the intensity of the reflected beam will be minimal and when the spot is at the center of the intermediate flat area between adjacent pits 6 or tracks 3, the intensity of the reflected beam will be maximal. The (radial) Push Pull signal (A+B)−(C+D) derived from the Quadrant photo detector of the optical unit 21 is also shown in FIG. 8. This signal is also called the radial error signal, which is used to differentiate between the different operation modes according to the present embodiment.

A high frequency (HF) information signal arises from the absorption and reflection of the actual pit 6 and land 7 regions in case those are present in a track 3, otherwise this HF information signal is more or less non-existing, except when e.g. scratches or other defects are present in or on the disc. However, this signal is not illustrated.

FIG. 8 is a more detailed view of the underlying principles for producing the P-signal. When the radial actuating mechanism of the laser pickup unit 20 moves the optical read device 21 in a radial direction 12 across the surface of the optical disc 1, the resulting output from the laser pickup unit 20 is the alternating signal P (illustrated in a low-pass filtered envelope). This is illustrated by arrow 54a. When transiting to the Tracked mode, a track 3 moves relative along the laser pickup head, as illustrated by arrow 54b.

Preferably, the signal P is sampled and converted into digital form by an Analog-to-Digital converter (ADC) 30 before further processing. By doing so, the flexibility of the system is increased since the subsequent processing of the signal is more easily performed in the digital domain, rather than in the analog counterpart, since new functions and calculation algorithms may be implemented in the digital domain without hardware modifications.

The signal P is then received in a processing device 40, which comprises a processor 41 and memory 45, as is illustrated in FIG. 7. The processor 41 may also be connected to input devices such as a keyboard 46 and a mouse 47, as well as to an output device such as a display 48. The processor 41 performs the above described quality testing method by executing program instructions stored in memory 45. Hence, the quality testing method determines a measure as to the quality of the optical disc 1 with respect to parameters in response to the measurement signal P obtained by the laser pickup unit 20.

The processor 41 may be implemented by any commercially available microprocessor. Alternatively, another suitable type of electronic logic circuitry, for instance an Application-Specific Integrated Circuit (ASIC) or a Field-Programmable Gate Array (FPGA) may substitute the controller 41. Correspondingly, the memory, the input devices 46, 47 and the output device 48 may all be implemented by commercially available components and are not described in any detail herein.

For clarity reasons, the quality testing method described above is divided into different functional blocks, as illustrated in FIG. 9. It should, however, be emphasised that these blocks may be implemented in hardware as well as in software.

In order to achieve correct measurements, the rotational speed of the optical disc 1 has to be adapted to the radial position of the optical read device 21. This is because as the optical read device 21 moves outward from the center of the disc 1, the pits move past the optical read device at a faster rate (the tangential speed of the pits is proportional to the radius times the speed at which the disc is revolving). As an alternative, since the relationship between tangential speed and radial position is known, the processing device 40 may subsequently compensate for effects arisen from readings at different radial positions.

The signal from the ADC 30 is fed into a selecting block 42 where relevant information signal parts are extracted from the signal P. The next block, the measuring block 43, receives the sequence of relevant signal information from the selecting block 42 in order to measure the signal levels of the relevant signal portion. The measurement values of the sampled information signal are preferably stored in the memory 45. An identifying block 44 in the processing device determines the signal components as described in the appendix from the signal.

The processor 41 of FIG. 7 is programmed to perform the above described quality testing method by reading a set of program instructions stored in the memory 45 and executing the program instructions sequentially in processor 41. In the flowchart of FIG. 9, the steps corresponding to the above described method are illustrated, namely:

Step 60 Start of the measurement procedure.

Step 61 Measurement of Tracked parameters.

Step 62 Is a statistically sufficient amount of data measured in the Tracked mode (i.e. is the amount of data sufficient to fulfill statistical requirements such as predetermined standard deviations, etc.)? If not, the Tracked operation mode continues in step 61.

Step 64 When a sufficient amount of data is measured in the Tracked mode, the measurement system orders the disc player to perform a short leap across the disc.

Step 66 Measurement of Off-Tracked parameters is begun and continues as long as the measurement system detects that the tracking mode is Off-Tracked in step 68.

Step 68 By monitoring the signals from the disc player's laser pickup, the measurement system's Tracking-algorithm can determine when the disc is in Off-Track mode, i.e. during the short leap. While the disc is in Off-Track mode, measurement of Off-Track parameters is performed, which is ensured by the interrogation of step 69.

The above sequence from steps 62 to 69 is subsequently repeated (looped back from step 70 to step 61) throughout the rest of the disc until the speed scanning routine for evaluating the quality of the entire disc ends with step 72. Alternatively only selected portions of a disc may be measured instead of an entire disc.

If the signals do not fulfill certain quality requirements for the disc manufacturer, the controller 40 may generate an alarm or provide another type of output through e.g. the display 48. Alternatively, the controller 40 may simply log all detected errors and other output data, e.g. on a hard disc, for later off-line use.

Applications and use of the above described embodiments of a method according to the invention are various and include fields such as manufacturing of pre-mastered or blank recordable optical storage discs.

The present invention has been described above with reference to a specific embodiment. However, other embodiments than the preferred above are equally possible within the scope of the appended claims, e.g. different disc formats, radial jump lengths and directions, pick-up principles etc. than those described above, performing the above method by hardware or software, etc.

As mentioned above, a disc within the frame of this specification is for instance a CD, DVD, BD, or generally any optical disc. A disc player is consequently a player which can read such a disc.

Even if the description above has referred to an optical disc having a single continuous spiral pattern of pits and plane areas, forming in essence a large number of concentric interconnected tracks, it is envisaged that the present invention may also be applied to other optical media, containing not a single spiral pattern but a plurality of non-connected circular or annular information tracks.

It is also envisaged that the quality testing method of the invention may be embodied as a computer program product, which is stored in a computer readable form on a suitable record medium (such as an optical or magneto-optical disc, a magnetic hard disc, an electronic memory) and/or is transferred as optical, electric or electromagnetic signals across a computerised network, and which contains a plurality of program instructions that, when read and executed by a computer, will perform the method according to the invention.

Furthermore, the term “comprises/comprising” when used in this specification does not exclude other elements or steps, the terms “a” and “an” do not exclude a plurality and a single processor or other units may fulfil the functions of several of the units or circuits recited in the claims.

### APPENDIX

The Quadrant Photo Detector

Different kind of combinations of the four detecting parts' output signals A, B, C and D, as shown in FIG. 5, result in a variety of different parameters of which the most important are given below both for the Tracked operation mode and the Off-tracked operation mode, as explained in the specification above.

A) Tracked Mode

HF Parameters, (A+B+C+D)

R14H

R14H is the same as I14H (see below), only expressed as reflectivity in percent. R14H is the top amplitude of the lowest frequency.

I14/I14H

The ratio between the peak-to-peak value of I14 pit/land and the I14H. This is a measure of the pit definition, i.e. how much interference the pits are causing. This parameter is sometimes referred to as I14 Modulation

I3/I14

The ratio between the peak-peak value of the shortest pit/land (I3) and the peak-peak value of the longest pit/land (I14) on the disc. This gives a measure of how well the I3 pits are formed in comparison to the I14. As I3 represents an important signal carrier, it is very important to have a large I3 signal (approximately 30% of all pits are I3).

ASYM

Asymmetry. Symmetry of the HF signal. This measurement indicates if I3 and I14 have different offsets in the HF signal. A disc player can handle a certain amount of asymmetry in the HF signal before digital errors occur.

DC Jitter

Jitter, Data to Clock. Measurement of the standard deviation of the time between all the data edges (pits and lands combined) compared to the reference clock edge. Presented as a percentage of the system bitclock period

Rb

Groove Reflectivity before recording. The amount of light reflected back to the detector from the groove before recording. A low value may indicate a thin reflective layer.

Digital Errors, Output Results from the Decoder

PIE

Parity Inner Error. This is the number of error corrections made in the first pass of the decoder using the inner parity correction code. Incoming rows of data are being corrected. PIE is measured over 1 ECC block. Max one PIE per row.

PIF

Parity Inner Fail. This is the number of error correction failures that occurred in the first pass. PIF is measured over 1 ECC block. Max one PIF per row.

Radial Push Pull (A+B)−(C+D)

Rad1b, Rad1a

Allowed residual error signal below 1.1 kHz measured using the reference servo for radial tracking. An increased signal level could indicate a physical radial track deviation (e.g. vibrations during mastering, stamper bumps or a worn out stamper). The parameter is measured before and after recording.

Rad2b, Rad2a

Allowed r.m.s. noise value of the residual error signal in a frequency band between 1.1 and 10 kHz. An increased signal level could indicate a physical radial track deviation (for instance vibrations during mastering, stamper bumps or a worn out stamper). The parameter is measured before and after recording.

WOSNRb, WOSNRa, WOCNRb, WOCNRa,

Wobble Carrier to Noise Ratio before and after recording. Carrier to noise ratio of the groove wobble signal before recording. The parameter is measured to check that the wobble carrier signal is clean enough to control the drive spindle speed. This parameter is measured when the drive is using Push Pull tracking.

ADERb

ADIP Error Rate before recording. ADERb is not specified, but measured according to Philips recommendations. It measures maximum number of ADIP blocks with an error over 8 ECC blocks. As every ECC block consists of 4 ADIP blocks, the max value is 32. Only for +R/RW.

WOBeat

Wobble Beat. The ratio between the maximum and the minimum wobble amplitude. The change in wobble amplitude is an effect of positive or negative interference with the wobble signal in the neighbouring tracks. If the value is too high, the drives will see a wobble signal that varies too much (too much interference from the neighbouring grooves). Only for +R/RW discs.

NWO

Normalized Wobble Signal. Normalized wobble amplitude gives a measure of the groove wobble amplitude in nm, measured before recording. The parameter is used to derive a drive independent signal indicating the wobble amplitude.

NWO is calculated from RPP amplitude in open loop, which is measured in the middle of the measured area. If PPb varies over the disc and the measured area is large, NWO will display incorrect values far from the center of the measured area Instead of measuring a large area, it is therefore better to measure a few smaller areas.

PWP

Phase wobble pre-pit. The phase difference between the land pre-pit and the wobble zero-crossing in degrees. This parameter is measured to ensure that the land pre-pit is located at the bottom of the wobble signal.

LPPb

Land Pre Pit level before recording. The land pre-pits are placed between tracks to get information about the current position. LPPb is the amplitude of the pre-pit, measured from the zero-crossing of the wobble signal, before recording (i.e. strength of the pre-pit signal). The land pre-pits are used for decoding of sector position and information to the recorder (write strategy codes, optimum recording powers, application codes, etc).

BLERb

Block Error Rate before recording. The amount of errors in the pre-pit signal before recording. The parameter is measured to determine the BLER value. A low BLER value ensures that the drive can find the correct position. Measured as a running window over 1000 ECC-blocks (approx. 24 seconds). BLER is always normalized as if there were 1000 ECC-blocks. This means that the value will be invalid (i.e. too low) during the first 1000 ECC-blocks (first 24 seconds) and is only available to make it possible to detect a problem at an early stage.

Focus Error, (A+D)−(B+C)

FEb, FEa

Focus Error. A measurement of the residual vertical error below 10 kHz. The parameter is measured before and after recording.

Tangential Push Pull, (A+C)−(B+D)

TPP

Tangential Push Pull (push pull in play). Push Pull in the tangential direction (along the tracks). A measurement of the optical sharpness of the leading and trailing pit edges, as seen by the optics.

B) Signal Parameters in Off-Track Mode

HF Parameters, (A+B+C+D)

TCSb, TCSa

Track Crossing Signal. Indicates how much the total intensity varies when crossing the tracks in the frequency range below 10 kHz. The parameter is measured before and after recording.

Radial Push Pull (A+B)−(C+D)

PPb, PPa

Push Pull before and after recording. The peak-to-peak value of the RPP signal measured over track crossings before and after recording. The parameter is measured to determine whether the tracking signal is good enough for tracing. To ensure certain tracking characteristics, the signal should be kept within the specified limits

Differential Phase Detection, phase (A+D)−phase (B+C)

DPD Amp

DPD Amplitude. Differential Phase Detection Amplitude. A signal below 30 kHz that indicate the tracking characteristics of a recorded or pre-mastered optical disc. To ensure certain tracking characteristics, the signal should be kept within the specified limits.

DPD Asym

DPD Asymmetry. Differential Phase Detection Asymmetry. The parameter indicates asymmetry in the DPD tracking signal that could result in an undesirable tracking offset.

1. A method for quality testing an optical disc (1) of the type that stores optically readable information in the form of a spiral or annular pattern (2) defining a plurality of concentric tracks (3), characterized by” the steps of: setting said disc (1) in rotation for optically reading out said disc (1) in different operation modes by a disc player having a read-out device for said disc (1), and for quality testing of said disc (1) intermittently alternating the steps of a) at least partly reading out at least one first track of said spiral or annular pattern (2) in a Tracked operation mode of said read-out device for determining Tracked quality parameters, and b) performing a leap in radial direction of said disc (1) and simultaneously analysing said disc (1) in an Off-track measurement operation mode during said leap for determining Off-Track quality parameters.

2. The method according to claim 1, wherein steps a) and b) are repeated until the overall quality of the optical disc (1) is tested starting from the innermost track of the disc (1) to the outermost track of the disc (1) or vice versa.

3. The method according to claim 1, comprising determining the current operation mode from a signal (P) directly derived from said read-out device (21, 14) during read-out.

4. The method according to claim 3, comprising analysing the signal amplitude of said signal (P) for determining said current operation mode.

5. The method according to claim 4, comprising determining that the current operation mode is the Tracked operation mode in case said signal amplitude is below a predetermined threshold of said signal, and determining that the current operation mode is the Off-track operation mode in case said signal amplitude exceeds said predetermined threshold.

6. The method according to claim 1, wherein said signal is the radial error signal (PP).

7. The method according to claim 1, comprising instructing the disc player to perform the leap in step b) when a statistically sufficient amount of data is measured in the Tracked mode in step a) for a predetermined quality level.

8. The method according to claim 1, wherein said leap is performed over a radial distance of said disc (1) not exceeding the predefined size of the smallest defect in or on said disc (1) that is to be detected during said quality testing.

9. The method according to claim 1, wherein said leap is carried out over at least one second track adjacent to said first track on said disc (1).

10. A computer readable medium having embodied thereon a computer program product directly loadable into an internal memory (45) associated with a processor (41), said processor being operatively coupled to an optical read device (21) and a drive mechanism (22) adapted to move the optical read device (21) radially over at least a portion of the surface of a disc (1), said disc being of the type that stores optically readable information in the form of a spiral or annular pattern (2) defining a plurality of concentric tracks (3), as to produce a measurement signal, the computer program comprising code segments for performing the method according to claim 1 when executed by said processor, said code segments being a first code segment for setting said disc (1) in rotation for optically reading out said disc (1) in different operation modes by a disc player having a read-out device for said disc (1), and for quality testing of said disc (1) intermittently alternating the second and third code segments for a) at least partly reading out at least one first track of said spiral or annular pattern (2) in a Tracked operation mode of said read-out device for determining Tracked quality parameters, and b) performing a leap in radial direction of said disc (1) and simultaneously analysing said disc (1) in an Off-track measurement operation mode during said leap for determining Off-Track quality parameters.

11. A method of quality testing of an optical disc (1) of the type that stores optically readable information in the form of a spiral or annular pattern (2) defining a plurality of concentric tracks (3), characterized by the step of determining a current operation mode from a signal directly derived from said a read-out device during read-out of said optical disc (1), wherein the current operation mode is determined being the Tracked operation mode in case the amplitude of said signal is below a predetermined threshold, and the current operation mode is determined being the Off-track operation mode in case said signal amplitude exceeds said predetermined threshold.

12. Use of a per-se known disc-player for performing the method of claim 1.
